(19) United States
(12) Patent Application Publication
(10) Pub. No.: US 2014/0038805 A1
(43) Pub. Date: Feb. 6, 2014

(54) DUNNAGE SUPPLY DAISY CHAIN CONNECTOR

(71) Applicants: Thomas D. Wetsch, St. Charles, IL (US); Christopher Rains, New Lenox, IL (US)

(72) Inventors: Thomas D. Wetsch, St. Charles, IL (US); Christopher Rains, New Lenox, IL (US)

(73) Assignee: Pregis Innovative Packaging, Inc., Deerfield, IL (US)

(21) Appl. No.: 13/566,659

(22) Filed: Aug. 3, 2012

(51) Int. Cl. B31B 1/00

(52) U.S. Cl. 493/464

(57) ABSTRACT

A chainable dunnage supply material, such as a roll of paper, for creating an extended or continuous supply of material, by chaining multiple units together. The dunnage supply arrangement comprises a first supply unit of an elongated web of material in a high-density arrangement, where the material may be converted into a low-density dunnage. The material has first and second longitudinal ends, and a connecting member is disposed adjacent to the first longitudinal end. The connecting member may include an adhesive surface for adhering to a longitudinal second end of a second supply unit of material with sufficient adhesion for pulling the material of the second supply unit into the dunnage mechanism (e.g. daisy chaining the two supply units together). The arrangement may include a release layer on the adhesive surface of the connecting member and releasable therefrom for allowing the connecting member to adhere to a second supply unit.

### FIELD OF THE DISCLOSURE

The present disclosure relates generally to an arrangement for daisy chaining supply units of dunnage material.

### BACKGROUND INFORMATION

In the context of paper-based protective packaging, rolls of paper sheet are crumpled to produce the dunnage. Most commonly, this type of dunnage is created by running a generally continuous strip of paper into a dunnage conversion machine that converts a compact supply of stock material, such as a roll or stack of paper, into a lower density dunnage material. The continuous strip of crumpled sheet material may be cut into desired lengths to effectively fill void space within a container holding a product. The dunnage material may be produced on an as needed basis for a packer. Examples of cushioning product machines that feed a paper sheet from an inside location of a roll are described in U.S. Patent Publication Nos. 2008/0076653, 2008/0261794, and 2012/0165172.

U.S. Patent Publication No. 2012/0165172 generally discloses a converter configured for pulling in a stream of sheet material and converting the material into dunnage. The publication further discloses that the supply units of sheets fed into the converter can be daisy-chained together, with the end of one supply unit attached to the beginning of the next supply unit.

It would therefore be desirable to employ an apparatus and method of continually feeding material into the dunnage conversion machines. More particularly, it would be desirable to be able to quickly or automatically load subsequent units of dunnage material supply.

### SUMMARY OF THE DISCLOSURE

The present disclosure provides supplying material for a line processing or a dunnage converting system and supply chain. The disclosure provides for, in one embodiment, a dunnage supply arrangement that links together (e.g. in a daisy chain) several supply units, for a virtual limitless supply of material.

In one embodiment, the dunnage supply arrangement, comprises a first supply unit of an elongated web of material in a high-density arrangement, where the material may be converted into a low-density dunnage in a dunnage mechanism. The elongated web of material has first and second longitudinal ends, and a connecting member is disposed adjacent to the first longitudinal end. The connecting member may include an adhesive surface configured for adhering to a longitudinal second end of a second supply unit of elongated web of material with sufficient adhesion for pulling the material of the second supply unit into the dunnage mechanism (e.g. daisy chaining the two supply units together). Further, the dunnage supply arrangement may comprise of a release layer disposed on the adhesive surface of the connecting member and releasable therefrom for allowing the connecting member to adhere to a second supply unit.

Additionally, the dunnage supply arrangement may include a sticker comprising the connecting member and a base member, where the base member is adhered to the first longitudinal end of the supply unit. The connecting and base members are positioned in a longitudinal relationship with respect to each other, and the base member has a transverse width that is greater than the transverse width of the connecting member.

Further, a grasping portion may be longitudinally connected beyond the adhesive surface of the connecting member and the first longitudinal end of the supply unit. The grasping portion may be substantially free of adhesive to facilitate grasping of the connecting member to peal the adhesive surface from the release layer.

In an embodiment, the supply units of the dunnage supply arrangement comprise of rolls of materials, where the first longitudinal end is an outer end of the roll, and the first longitudinal end is an inner end of the roll that is extendible from the interior of the roll to attach to a connecting member of a another supply roll. Additionally, the axial height of the roll unit may be greater than about 1 foot; however, other axial heights are also possible. A sticker, having a connecting member and base member, is adhered to the roll, where the connecting member extends beyond the first longitudinal end of the roll and the base member adheres to the first longitudinal end of the roll.

Where the supply units comprise of rolls, the dunnage supply arrangement, in an additional embodiment, may further comprise of a release layer affixed to a portion of the web material adjacent and longitudinally beyond the first end of the roll.

Alternatively, the supply units may be stacks of paper folded in fan-folded layers, a tractor feed, a wind, or other similar source.

In another embodiment, the dunnage supply arrangement may further comprise a dunnage mechanism configured for converting the elongated web material into the low-density dunnage, wherein the first end of the material is loaded into the dunnage mechanism, and a second supply unit, having similar construction to the first supply unit. The second longitudinal end of the second supply unit is positioned for adhering to the adhesive layer of the connecting member of the first supply unit when the release layer is released therefrom. The first supply unit is then stacked on the second supply unit with the second longitudinal end of the second supply unit disposed adjacent the connecting member of the first supply unit for adhering thereto. The dunnage supply arrangement may further comprise of a third supply unit, having similar construction to the second and first supply unit. The second longitudinal end of the third supply unit is positioned for adhering to the adhesive layer of the connecting member of the second supply unit when the release layer is released therefrom. The second supply unit is then stacked on the third supply unit with the second longitudinal end of the third supply unit disposed adjacent the connecting member of the second supply unit for adhering thereto.

Following the stacking arrangement discussed above, in another example embodiment, the supply units may comprise of rolls of materials such that the second end of the second and third roll extends out from the center of the second and third roll respectively from between the stacked rolls.

A dunnage supply arrangement, in another embodiment, may comprise of a first supply unit of an elongated web of material in a high-density arrangement as discussed above, a sticker, and a release layer affixed to a portion of the web material adjacent and longitudinally beyond the first end of the unit. The sticker further comprises a connecting member extending beyond and adjacent the first longitudinal end of the unit and a base member adhered to the first longitudinal end of the unit. Additionally, the connecting member has an adhesive surface configured for adhering to the release layer and releasable therefrom to allow adhering to a longitudinal second end of a second supply unit of the elongated web of material with sufficient adhesion for pulling the material of the second supply unit into the dunnage mechanism. The supply units may comprise of rolls of materials, where the second longitudinal end is the inner end of the roll extending therefrom.

In an additional embodiment, the dunnage supply arrangement can include a first supply unit of an elongated web of material in a high-density arrangement as discussed above, and a connecting member. The connecting member has at least one adhesive surface portion and disposed on the supply unit such that the adhesive surface faces outwardly. In one embodiment the supply units are rolls of material and the connecting member is a strip of material that is disposed on the outer layer of the roll with the adhesive facing outwardly or on the exterior surface. A first supply unit is then stacked on a second supply unit, and the second longitudinal end of the second supply unit is adhered to the outward adhesive surface of the connecting member of the first supply unit. Alternatively, the strip may be disposed on the bottom surface of the roll such that when the first supply unit is stacked on a second supply unit, the second longitudinal end of the second supply unit adheres to the outward adhesive surface of the connecting member of the first supply unit.

The present disclosure also provides for a method of loading a dunnage mechanism, where a user first pulls an inner end of a first roll of an elongated web of material from a first roll. The user then removes a connecting member disposed at the outer end of a second roll from a release layer disposed on the outer layer of the second roll. Once released, the user stacks the second roll on the first roll with the inner end extending between the first and second rolls and affixes the connecting member of the second roll to the inner end of the first roll to pull the inner end of the first roll into the dunnage machine, which is configured for converting the material into low-density dunnage.

Additional advantages and novel features of the examples will be set forth in part in the description which follows, and in part will become apparent to those skilled in the art upon examination of the following description and the accompanying drawings or may be learned by production or operation of the examples. The advantages of the concepts may be realized and attained by means of the methodologies, instrumentalities and combinations particularly pointed out in the appended claims.

### BRIEF DESCRIPTION OF THE DRAWINGS

Further features and advantages of the present disclosure will become apparent from the following detailed description taken in conjunction with the accompanying Figures showing illustrative embodiments of the present disclosure, in which:

FIG. 1 is a rear view of an embodiment of a dunnage mechanism with a stabilizer for daisy chained stacks;

FIGS. 2A and 2B depict an exemplary embodiment of a dunnage supply unit with a daisy-chaining sticker respectively in an initial condition and with a connective member released from a release layer;

FIG. 2C is an illustrative view of a rolled supply unit;

FIG. 3 is a front perspective view of another embodiment of the sticker;

FIG. 4 depicts an exemplary embodiment of daisy chained supply units used with the system of FIG. 1;

FIG. 5 is a perspective view of an exemplary plurality of chained stacks of dunnage units, according to an exemplary embodiment;

FIGS. 6A and 6B depict a bottom view of an embodiment of a dunnage material supply unit with the sticker of FIG. 3 adhered thereto;

FIG. 7A is a front view of an embodiment of the converting station in accordance with the present disclosure;

FIG. 7B is a cross-sectional, left-side view through the converting station of FIG. 7A;

FIG. 8 is a side view thereof;

FIG. 9 is a rear view thereof;

FIGS. 10 and 11 depict supply units according to other embodiments; and

FIG. 12 depicts an exemplary embodiment of a dunnage supply unit with a daisy-chaining sticker.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures.

### DETAILED DESCRIPTION OF THE DISCLOSURE

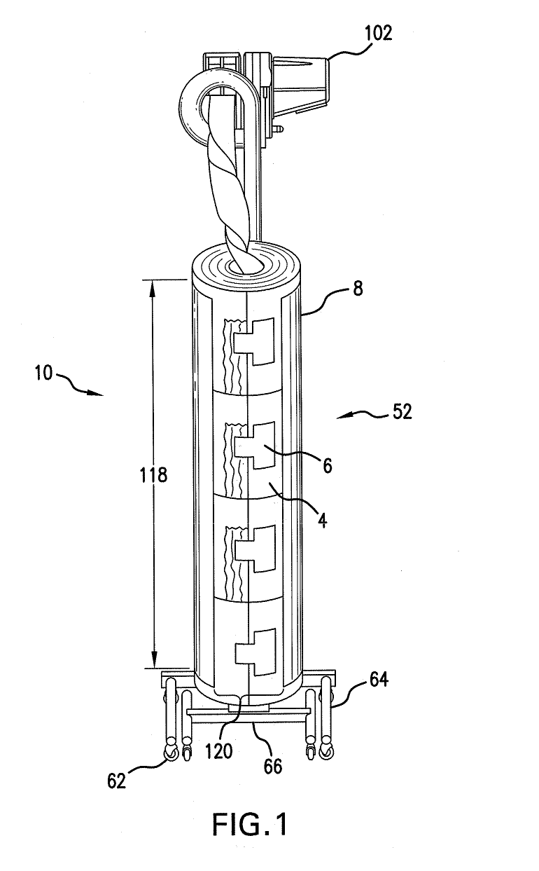

The present disclosure is generally applicable to supply units for systems where the supply units are processed or converted. As shown in FIG. 1, the system 10 preferably includes a converting station 102, supply units 4 preferably daisy chained together by a sticker 6, and a stabilizer 8. The system 10 is configured to pull a continuous stream or daisy chain of sheet material from supply units 4, and the continuous stream of sheet material is fed from the supply units 4 into a converting station 102 to be converted into a low-density stock material, such as dunnage. One of the operating features of the system 10 is the production of a generally continuous supply of dunnage that can be severed as needed, to any length, and different lengths throughout use. By daisy chaining the supply units 4 together, a continuous and uninterrupted feed of material can be fed to the converting station 102.

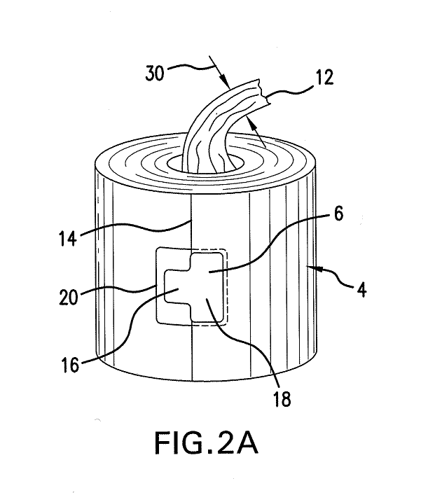

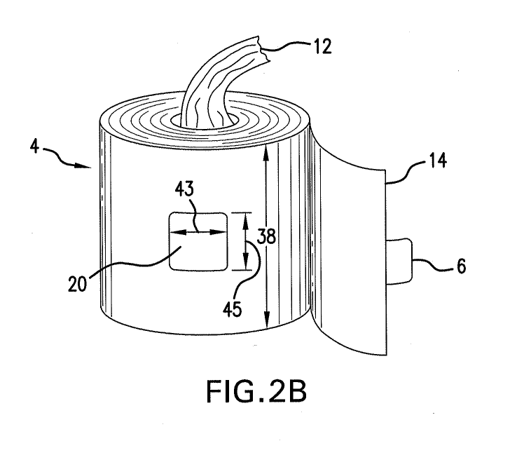

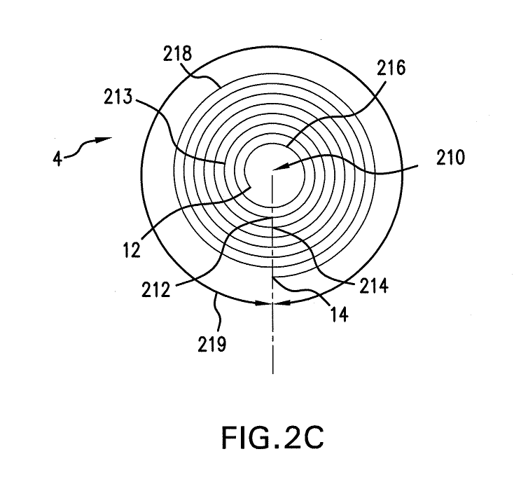

Preferably the supply units 4 comprise paper stock in a high-density configuration having a first longitudinal end and a second longitudinal end. In the preferred embodiment, the supply units 4 comprise of coreless rolls as shown in FIGS. 2A-2C where the first longitudinal end is the inner end 12 of the roll, and the second longitudinal end is the outer end 14 of the roll extending therefrom and opposite the outer end. As shown in FIG. 2C, the rolls are formed by winding a ribbon of sheet material, preferably to leave a hollow center 210, rolling the material up into a roll with multiple layers. Each layer in the supply roll is a longitudinal length of the ribbon of sheet material that extends about a single revolution 219 in the roll, and about layers that are internal with respect thereto. The sheet of material may be made of a single ply or multiple plies of material. Where multi-ply material is used, a layer can include multiple plies. Each layer includes inner and outer layer ends 212, 214, as shown in FIG. 2C. In the exemplary roll illustrated in FIG. 2C, the layer ends 212, 214 are disposed a same circumpherential position on the roll. The outer end 214 of one layer continuous and contiguous with the inner end 212 of the next outer layer, and inner end 212 of one layer continuous and contiguous with the outer end 214 of the next inner layer. For example, the circular line 219 shown in FIG. 2C depicts an exemplary illustration of a single layer 213 having an inner end 212 and an outer end 214. The outermost layer 218 of the roll in the embodiment shown has the outer surface of the roll.

In the preferred embodiment, the roll 4 and its hollow core 210 are substantially cylindrical to form a cylindrical roll. Alternative embodiments of the roll can be provided in different shapes, such as flattened rolls with oval, square, rectangular, triangular, or other regular or irregular cross-sections. It is also appreciated that other types of material can be used, such as pulp-based virgin and recycled papers, newsprint, cellulose and starch compositions, and poly or synthetic material, of suitable thickness, weight, and dimensions.

In the preferred embodiment, as shown in FIGS. 2A and 2B, the supply units 4 or rolls comprise a sticker 6 having a connecting member 16 and a base member 18, which are longitudinally adjacent to each other, as well as a release layer 20. Preferably the sticker 6 comprises both the connecting 16 and base member 18; however, the sticker 6 may comprise of only the connecting member 16 or only the base member 18 disposed at the end of the outer end 14 or lined on the bottom end of the outer end 14 such that the adhesive faces the inward or interior layers of the roll 4.

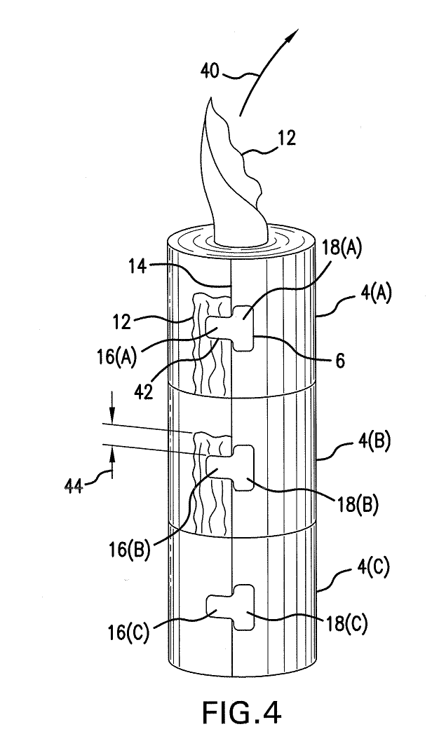

As shown in FIG. 4, the transverse width 24 of the base member 18 is preferably larger than the transverse width 22 of the connecting member 16. For example, preferably, the transverse width 24 of the base member 18 is about 5% to 60% more than the transverse width 22 of the connecting member 16. Further, the base member 18 preferably has a longitudinal length 26 of about at least ½″, and most preferably about at least 1½″ or 2″. The base member 18 preferably has a longitudinal length 26 about up to 8″.

Preferably, the connecting member 16 has a longitudinal length 28 about at least 1″. The connecting member 16 has a longitudinal length 28 preferably is about up to 8″. In the preferred embodiment, the longitudinal length 28 of the connecting member 16 is preferably sufficient to adhere to the inner end 12 of a supply unit 4. For example, the connecting member 16 preferably has a longitudinal length 28 that is less than the width 30 of the bunched up inner end 12 that has been pulled out from the center of the roll, such that it links the inner end 12 of the roll to the outer end 14 of a second or bottom roll (this arrangement is described further in FIGS. 1, 4, and 5 below). In other embodiments, the connecting member 16 can have a longitudinal length 28 that is longer than the width 30 of the inner end 12, such that the connecting member 16 links the inner end 12 of the bottom unit or roll to the outer end 14 of a top unit or roll, as well as adhere the inner end 12 of the bottom unit to the outer layer of the top unit

The base member preferably has a transverse width 24 about at least 1″. The base member preferably has a transverse width 24 about up to 8″. The connecting member 16 preferably has a transverse width 22 about at least 1″. The connecting member 16 preferably has a transverse width 22 about up to 8″. In the preferred embodiment, as shown in FIGS. 1, 2A-2B, and 6A-6B, the transverse width 24 of the base member 18 is larger than the transverse width 22 of the connecting member 16. In alternative embodiments, the sticker 6 may be designed such that the transverse width 22 of the connecting member 16 is larger than the transverse width 24 of the base member 38.

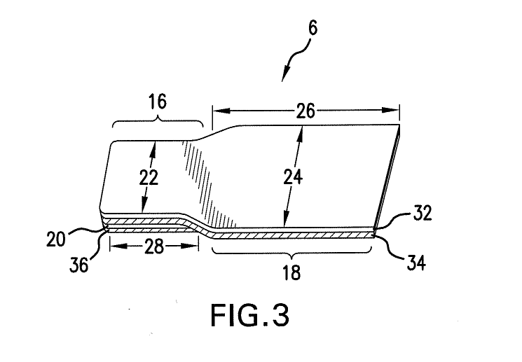

As discussed above, in the preferred embodiment, the supply unit 4 or roll comprises a sticker 6 having a connecting member 16, base member 18, and release layer 20. As shown in FIG. 3, the connecting member 16 and base member 18 can comprise a plurality of layers. For example, the first layer 32 can be a face stock or label that can be configured to receive writing, such as from a printer, pen, pencil, or marker. In the preferred embodiment, the face stock is made from a synthetic poly-material that is moisture resistant, thermal transfer receptive, and flexible and strong enough to provide prevent tearing while fed through the converting station 102. It is also appreciated that other types of material can be used, such as pulp-based virgin and recycled papers, newsprint, cellulose and starch compositions, poly or synthetic material, or other similar materials of suitable thickness, weight, and dimensions. The second layer is an adhesive layer 34 that has an adhesive lining, where the adhesive layer 34 is sufficiently strong enough to bond with the longitudinal ends 12,14. Preferably the adhesive is an emulsive pressure-sensitive adhesive such as acrylic, but other suitable adhesive can be used, i.e. rubber, tape, glue, and other suitable adhesives. The adhesive lining on the adhesive layer 34 can be substantially the same size as the face stock or label 32, or can be smaller than the face stock or label 32. The adhesive lining 34 may be of other shapes and configurations as long as it sufficiently strong enough to bond with the inner 12 and outer ends 14.

Further, as depicted in FIGS. 2A-2B, preferably the connecting member 16 and base member 18 of the sticker 6 are manufactured separately from the release layer 20. The release layer 20 allows for the adhesive layer 34 lining the connecting member 16 and base member 18 to be easily released, lifted, or removed from the release layer 20 while still maintaining an adhesive lining sufficiently strong enough to bond with the inner 12 and outer ends 14, and the outer layer of the roll 4. Preferably, the release layer 20 is made from a clear bi-axially oriented polypropylene material that is coated with silicone to facilitate the connecting member 16 to be easily released from the release layer 20. It is appreciated that the release layer 20 can be made from other suitable materials such as other types of polyproplyene material.

The release layer 20 is lined with a second adhesive layer 36 (not shown in FIG. 2A-2B) which allows the release layer 20 to be adhered to the outer layer of the roll 4 as depicted in FIG. 2B. The adhesive is preferably an emulsive pressure-sensitive adhesive such as acrylic, but other adhesive can be used, i.e. rubber, tape, glue, and other suitable adhesives. Preferably, the release layer 20 is dimensioned to be larger than the connecting member 16 or sticker 6 to account for manufacturing error of the sticker 6. This also allows for a greater tolerance when repositioning the sticker 6. The release layer 20 has a longitudinal length 43 (shown in FIG. 2B) about at least 1″. The release layer 20 has a longitudinal length 43 about up to 16″. The release layer 20 has a transverse width 45 about at least 1″. The release layer 20 has a transverse width 45 of about up to 10″. In other configurations, the release layer 20 can be dimensioned such that it is at least the size of the connecting member 16. Alternatively, other shapes and configurations of the release layer can be used. For example, in alternative embodiments, the release layer 20 can be equal to or smaller than the area of sticker 6, or the release layer 20 can comprise of a plurality of shaped portions of the release layer 20 having a configuration that allows the adhesive layer 34 to easily be released, lifted, or removed from the release layer 20.

Preferably, the release layer 20 can be disposed such that a portion of the release layer 20 is adhered to the first outer layer of the roll 4, and an adjacent portion of the release layer 20 is adhered to the first inner layer of the roll 4 adjacent to and contiguous with the outer layer (as illustrated in FIG. 2A). In other configurations, the entire release layer 20 is positioned on outer layer of the roll (not shown). The outer layer of the roll is defined as the layer starting at the outer end 14 to the portion adjacent and opposite the outer end 14.

In one example embodiment of the longitudinal length 28 of the connecting member 16 has a transverse width 22 of about 3″, and has a longitudinal length 28 of about 3½″. The exemplary sticker 6 is made from a synthetic material similar to a paper material, and is also preferably moisture resistant. The sticker 6 can be about 3 millimeters thick and the first layer 32 or face stock is coated with silicone. The first layer 32 is additionally thermal resistant. The release layer 20 of this exemplary sticker 6 has a transverse width 45 of about 3¾″ and a longitudinal length 43 of about 3¾″. Further, the release layer 20 of this exemplary embodiment is about 2 millimeter thick bi-axially oriented polypropylene coated with silicone. In the exemplary sticker 6, the adhesive layer 34 that lines the first layer 32 or face stock as well as the adhesive layer 34 that lines the release layer 26 are made from an emulsive pressure-sensitive acrylic adhesive, and have a tack of 36.0 ounces per inch. It is appreciated that other suitable constructions of the sticker 6 can alternatively be used.

As illustrated in FIG. 2A, the sticker 6 can be used to facilitate packaging and transportation of the supply units 4. In the embodiment illustrated in FIG. 2, for example, the sticker 6 is adhered to the outer end 14, similarly as discussed above, and the connecting member 16 or sticker 6 is adhered to the release layer 20 such that the outer end 14 is adhered to the outer layer of the roll 4. Thus, allowing for the supply units 4 to be configured for easy packaging and transporting of the supply units 4.

In an alternative embodiment of the sticker 6, as shown in FIG. 3, the release layer 20 may be integrated with the connecting member 16 such that the connecting member 16 further comprise two additional layers: a release layer 20 and a second adhesive layer 36. The second adhesive layer 36 may be substantially the same size as the connecting member 16 or may be smaller than the connecting member 16. The release layer 20 and second adhesive layer 36 may be configured such that when storing or transporting each supply unit, the sticker 6 adheres the inner end 12 of the roll to the outward or exterior layer of the same roll in the same manner as discussed in FIG. 2A-2B above.

In another embodiment, an adhesive layer can line the inner portion of the outer end 14 and the release layer 20 can be positioned directly thereunder on the inner or interior layer of the roll, such that the adhesive layer on the inner portion of the outer end 14 directly overlaps the release layer 20 disposed on the inner layer.

In still another embodiment of the sticker 6, the sticker 6 can further comprise a grasping portion disposed at the end of the connecting member 16, but not secured to the supply unit 4. The grasping portion preferably has no adhesive quality and facilitates releasing the connecting member 16 from the release layer 20. Alternatively, the grasping portion can be created by adding an additional layer to the adhesive layer 34 thereby preventing that portion of the adhesive 34 from bonding onto the release layer 20.

Additionally, in another embodiment of the sticker 6 shown in FIG. 3, the sticker can further include additional release layers. By having an additional release layer or layers lining the bottom of the sticker 6, the stickers 6 can be packaged and manufactured separately from the supply units 4. In one embodiment, a release layer can line the bottom of the connecting member 16 and a separate release layer can line the bottom of the base member 18. In such configuration, a user can independently lift the release layer from the base member 18 and adhere it to supply units, for example either at the inner end 12 or outer end 14 of the rolls 4. Subsequently, the user can then lift the additional release layer from the connecting member 16 and adhere the connecting member 16 to a desired location, for example, either at the inner end 12 or outer end 14 to the same or different roll. In other configurations, an additional release layer can line both the bottom of the connecting member 16 and the base member 18. Similarly to as described above, by having an additional release layer, a user can easily lift the release layer from the sticker 6 and adhere the sticker 6 where desired.

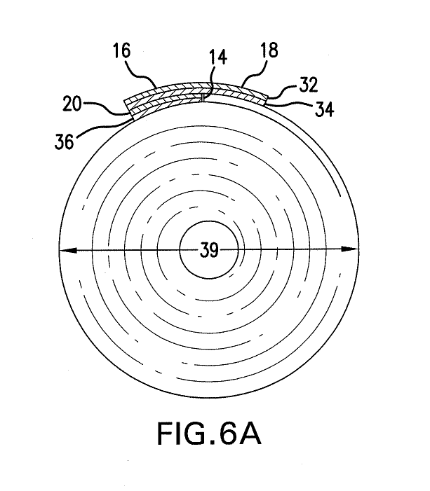

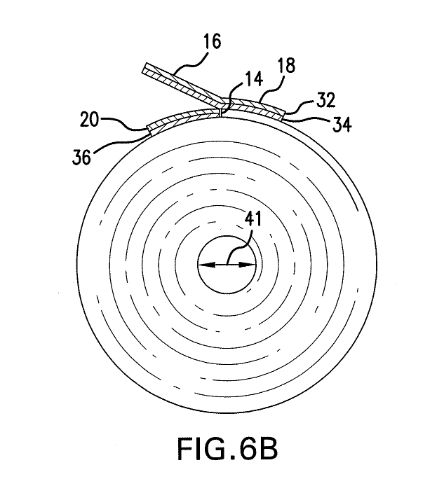

In the preferred embodiment, the supply units 4 are daisy chained together by the sticker 6 discussed above, such that a continuous stream of sheet material can be fed into a converting station 102 to be converted into a low-density stock material, such as dunnage. In the embodiment shown in FIG. 4, preferably the multiple supply units 4(A), 4(B), and 4(C) (preferably rolls, but other configurations can be used) are daisy chained to one another allowing for an uninterrupted feeding of the system when a upper roll 4(A) of material is exhausted. In this embodiment, for example, the rolls have two longitudinal ends, where the first longitudinal end is the outer end 14 and on the opposite longitudinal side of the ribbon of sheet material from the inner end 12. The second longitudinal end is the inner end 12 of the roll, and is shown having been pulled axially from the center of the roll in an upward direction 40. The inner end 12 further has a connecting portion 42 that adheres to the sticker 6 as discussed below. The axial height 38 (shown in FIG. 2B) of the rolls is preferably about at least 5″. The axial height 38 of the rolls is preferably about up to 80″. The outer diameter 39 (shown in FIG. 6A) of the rolls is preferably about at least 5″. The diameter 39 of the rolls is preferably about up to 24″. The inner diameter 41 (shown in FIG. 6B) of the center of the roll 4 is typically about at least 2″ or at least 3″. The diameter 41 of the center of the roll is typically about up to 8″, more preferably up to about 6″ or 4″. Other suitable dimensions of the supply rolls can be used. Further, preferably each roll weighs about 20 to 60 pounds.

In one example embodiment of the rolls, the outer diameter 39 of the roll is about between 11″ to 12¼″, and the inner diameter 41 is about 3″ to 6″. Additionally, in this example embodiment, the each roll weighs about 30 to 45 pounds.

Preferably, in the exemplary embodiment shown in FIG. 4, the base member 18(A) of the sticker 6 is adhered to the outer end 14 of the upper roll 4(A) and the connecting member 16(A) is connected to the connecting portion 42 of the inner end 12 of the middle roll 4(B). Similarly, another base member 18(B) is adhered to the outer end 14 of the middle roll 4(B) and another connecting member 16(B) is connected to the connecting portion 42 of the inner end 12 of a lower roll 4(C). The lower roll 4(C) can be similarly be connected to another roll directly below it, and so on. Thus, creating a link between the upper roll 4(A), middle roll 4(B), lower roll 4(C), and so on. Preferably, the outer end 14 of the upper unit can overlap the inner end 12 of the lower unit when the sticker 6 is attached. Alternatively, the outer end 14 of the top unit can be disposed adjacent to the inner end 12 of the bottom unit when the sticker 6 is attached.

Once the supply units 4 are daisy chained together as discussed in the preferred embodiment, the inner end 12 of the upper supply unit 4 or roll is fed into the converting station 102. During operation of the system 10, for example, once the upper roll 4(A) is consumed by the converting station 102, the converting station 102 automatically begins feeding from the inner end 12 of the lower roll, in this embodiment the middle roll 4(B), disposed directly thereunder, and again, after the middle roll 4(B) is consumed, the converting station 102 automatically begins feeding from the inner end 12 of the lower roll 4(C) and so on. The base member 18 or sticker 6 is preferably positioned in the center or middle of the outer end 14 to help distribute stresses more evenly between the ends of the two attached rolls (i.e. the outer end 14 of the upper roll attached to the inner end 12 of the lower roll). In other embodiments, the base member 18 or sticker 6 can be positioned at various positions on the outer end 14, but not necessarily in the center or middle of the outer end 14.

In another embodiment, the sticker 6 can be initially attached to the inner end of the lower roll, where the inner end is pulled from the center of the lower roll and adhered to the outer end of the upper roll. For example, similarly as discussed above, the inner end of the lower roll, which is connected to the sticker, adheres to the outer end of the upper roll, and the inner end of the upper roll, which is connected to the sticker, adheres to the outer end of the roll positioned directly above, and so on. Thus, forming a daisy chain of material.

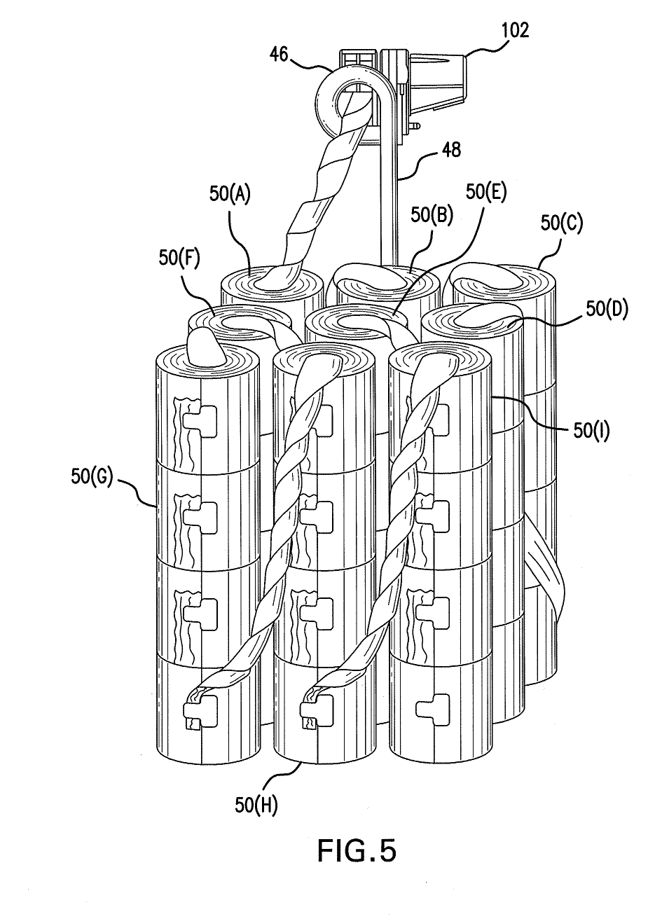

Further, the distance 44 at which the sticker 6 is placed on the connecting portion 42 of the inner end 12 may be right or close to the end of the inner end 12, or more preferably the distance 44 is about 1″ to 4″ from the end of the inner end 12. For purposes of this illustration, FIG. 4 references three rolls; however, an infinite number of rolls may be chained together as depicted in FIG. 5.

As depicted in FIG. 4, the supply units 4 or rolls are stacked or otherwise arranged in a vertical end-to-end manner in the preferred embodiment. By daisy chaining the rolls together and arranging them in a vertical end-to-end manner, the supply units 4 or rolls are aligned radially around a vertical axis. Such arrangement allows the daisy chained units or rolls to be pulled into the converting station 102 with less resistance. A similar arrangement could also be provided with the supply units 4 arranged in a horizontal end-to-end manner. The units 4 can be oriented such the inner end 12 of the top unit is fed into the converting station 102 and has a counter clockwise spiraling coil that is fed into the converting station 102 as shown in FIGS. 1 and 5. Alternatively, the units 4 or rolls may be oriented such that the inner end 12 of the top unit has a clockwise spiraling coil. Further still, the inner end 12 of the units 4 may be oriented without a coil, but folded, crumpled, or other similar fashion.

As an illustrative example of the disclosed system, a user stores the supply units 4 by adhering the entire sticker 6 onto a supply unit 4 such that the base member 18, shown in FIG. 6A, is adhered to the second longitudinal end 32 of the supply unit (illustrated as a roll in FIG. 6A for example purpose) and the connecting member 16 is adhered to the outward layer of the unit or roll adjacent to the outer end 14 by the second adhesive layer 36. To chain each roll together, the user releases or lifts one end of the connecting member 16 off an upper roll, as depicted in FIG. 6B. The first adhesive layer 34 becomes released from the release layer 20, which allows the connecting portion 42 of a inner end 12 of a lower roll to be adhered to the connecting member 16, and thus chained to the outer end 14 of the upper roll. In configurations where the sticker 6 comprises a grasping portion, the user can lift the grasping portion to release the connecting member 16 from the release layer 20.

Preferably, as shown in FIGS. 1 and 5, the system 10 comprises multiple supply units 4 stacked on one another and daisy chained together, with the inner end 12 of the bottom supply unit is attached the outer end of the top supply unit, so that the outer end 14 of the top supply unit pulls the inner end 12 of the bottom supply unit into a converting station 102. Thus, an infinite number of supply units can be chained together to create an uninterrupted stream of sheet material. As the inner end 12 is fed into the converting station, the interior layers begin to unwind layer by layer. The outer layer 218 is the last layer of the roll to be pulled into the converting station 102.

In one configuration, as shown in FIG. 5, chains of supply units can also be constructed from multiple stacks of supply units, e.g., in a row, such as the rows illustrated in FIG. 5 with stacks 50(A) to 50(I). Further still, the end of one row can be attached to the start of another row, forming an N by M pallet of stacks, and a cuboid of supply units (e.g. the pallet of stacks illustrated in FIG. 5). Additional pallets can be concurrently connected or added to currently connected pallets, to provide additional continuous material supply.

As an example of the chainable pallet of stacks, FIG. 5 depicts the system 10 having the converting station 102, inlet guide 46, support portion 48, and a 3×3 pallet of supply units 4 (illustrated as rolls in FIG. 5). The inner end 12 of the upper roll of the first stack 50(A) is fed into the converting station 102 through the inlet guide 46. Similarly to the arrangement depicted in FIG. 4, the stacks are chained together using the sticker 6 discussed above to form a continuous supply of material. The inner end 12 of upper roll of the second stack 50(B) is pulled from the inner portion of the roll and adhered to the bottom roll of the first stack 50(A) by the sticker 6 in a similar manner as described above. Similarly, the inner end 12 of the upper roll of the third stack 50(C) is pulled from the inner portion of the roll and adhered to the last roll of the second stack 50(B) by the sticker 6. In a similar fashion, the inner end 12 of the upper roll of the fourth stack 50(D), positioned directly behind the third stack 50(C), is pulled from the inner portion of the roll and adhered to the last roll of the third stack 50(C), and so on such that a continuous chain is formed. As depicted, the inner ends 12 of the stacks 50(A), 50(H), and 50(I) are coiled, but the ends do not necessarily need to be coiled. Instead, the inner ends 12 can be straight, folded, crumpled, or other similar forms. For illustrative purposes, FIG. 5 depicts a 3×3 pallet of rolls having four rolls per stack, but as discussed above, the stacks may have an infinite amount of rolls and the pallets may be comprised of an infinite amount of rows and may have other configurations. Further, for purposes of this illustrative example in FIG. 5, the first stack is the stack being fed into the converting station 102, and the second stack is the stack chained directly next to it, and so on; however it should be appreciated that the stacks could have other configurations (i.e. the first stack could be the middle stack which is fed into the converting machine 102 or the third stack could be the starting stack initially being fed into the converting machine 102).

In an additional exemplary embodiment, as shown in FIG. 1, multiple supply units 4 can be stacked on one another within a stabilizer 52 and daisy chained together, with the inner end 12 of one supply unit 4 attached to the preceding supply unit, as described above, so that the outer end 14 of one supply unit pulls the inner end 12 of the next supply unit into the converting station 102. The preferred width 30 of the material being fed through the converting station 102 is about at least 1″, more preferably about at least 2″, and most preferably about at least 4″. The preferred width 30 of the material being fed through the converting station 102 is about up to 30″, and more preferably about up to 10″. The preferred dimensions of the material being fed through the converting station 102 is about at least ½″ thick. The preferred dimension of the material being fed through the converting station 102 is about up to 3″ thick, and more preferably about up to 2″ thick. FIG. 1 illustrates supply units 4 comprising of rolls, but the supply units 4 can be stacks of papers, tractor feed, fan-folded source, a wind, or other similar form.

The stack of supply material units 4 can stand on its own, as depicted in FIG. 5, or can be arranged in a supply handling unit, such as a stabilizer 52, as shown in FIG. 1, where the stabilizer 52 compresses inwardly against the supply units to prevent the supply units from collapsing and large portions of the supply units from being pulled into the converting station 102 and jamming the machine. Another benefit of a compressed stabilizer 52 is that it accounts for variation in roll size and basis weight within a stack. For example, the outside roll diameter in a stack may vary up to ½″ between each roll, and basis weight may change between 30 to 65 pounds per 3,000 square feet.

The exemplary stabilizer 52 illustrated in FIG. 1 depicts a stack of rolls held within a supply handling unit, such as a the stabilizer 52, where the rolls are daisy chained together as described above, and the inner end 12 of the upper roll is fed into the converting station 102. The exemplary stabilizer 52 shown includes an opening in the front to allow users to, for example, identify the rolls as well as detail loading and operating instructions written, for example, on the sticker 6. In one embodiment of the supply handling unit, multiple stabilizers 52 can be stacked, and the rolls within the stacked stabilizers 52 are daisy-chained together.

Preferably, the stabilizer 52 maintains the shape of the rolls, and keep the rolls from collapsing when only a few layers are left in each roll, such by gently applying compressive pressure to the outer surface of the rolls. This can prevents large portions of rolls, including several layers thereof, from being forced or pulled into the converting station 102 at once without unwinding first. In one embodiment of the stabilizer 52, the stabilizer 52 walls can extensively cover the outer surface of the rolls to spread the compression amount around the circumference of the rolls, and preferably results in the last layer of the roll being pulled into the converting station without inner layers of the same roll.

Preferably, the stabilizer 52 walls can be biased by a spring, or be made of a resilient, flexible material, for example, being naturally spring-biased inwardly against the outer layers of the rolls. Such a stabilizer 52 can be made of a thermoplastic material, such as acrylonitrile butadiene styrene, which provides enough flexibility to allow users to separate the wall 226 during loading of the supply units. In other embodiments, the stabilizer wall can be made of a high impact poly-styrene, high-density polyethylene, other types of plastic or thermoplastic material, cardboard, metal, or other similar material. Alternative means of compressing the stabilizer walls can be used, such as a rope, string or bungee cord, which may be found in common commercial stores, wrapped around the tube.

As discussed above, in the preferred embodiment, the system 10 is configured to pull continuous stream or daisy chain of sheet material 19 from supply units 4 and into a converting station 102, where the converting station 102 converts the high-density configuration into a low-density configuration. The material can be converted by crumpling, folding, flattening, or other similar methods that converts high-density configuration to a low-density configuration. Further, it is appreciated that various structures of the converting station 102 can be used, such as those converting stations 2 disclosed in U.S. Application No. 61/537,021, U.S. Publication 2012/016172, U.S. Publication No. 2011/0052875, and U.S. Pat. No. 8,016,735.

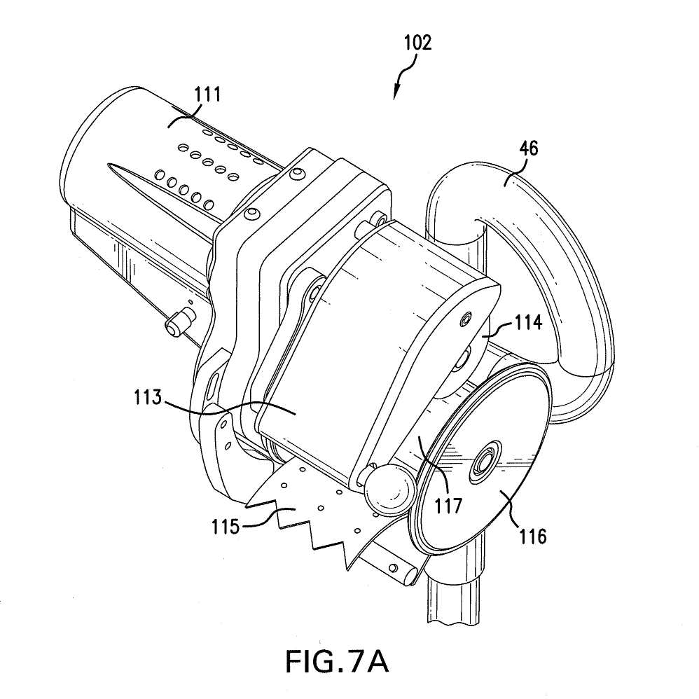

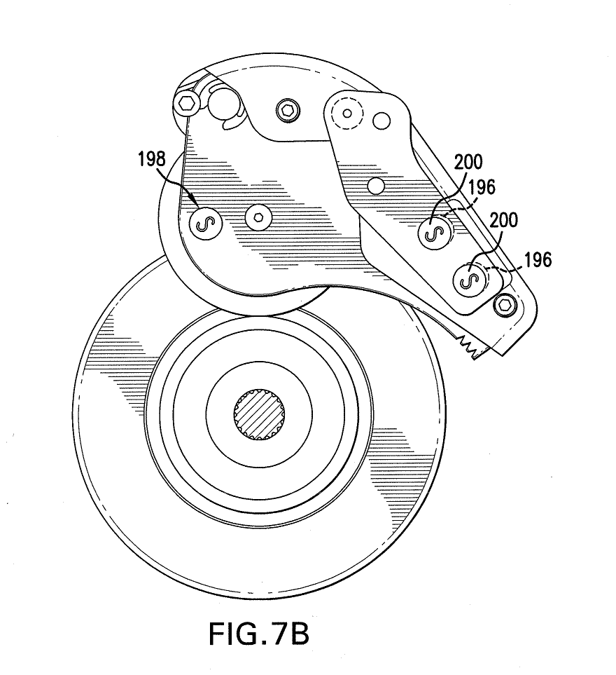

In the preferred embodiment, as shown in FIG. 7A, the system 10 includes an actuator 111, such as an automated motor, for driving the material 19. An actuator 111 can be connected to a power source, such as an outlet via a power cord, and can be arranged and configured for driving the system 10. The actuator 111 may be part of a drive portion, and the drive portion may include a transmission portion for transferring power from the actuator. Alternatively, a direct drive may be used. The actuator 111 can be arranged in a housing and can be secured to one side of the central housing. The transmission may be contained within the central housing and may be operably connected to a drive shaft of the motor and a drive portion thereby transferring motor power.

In one exemplary embodiment, as shown in FIGS. 7-9, the converting station 102 includes a pressing portion 113 that can have a pressing member 114 such as a roller or rollers. The rollers 114 may be supported via a bearing or other low friction or frictionless device positioned on an axis shaft arranged along the axis of the rollers 114. The rollers 114 may have a circumferential pressing surface arranged in tangential contact with the surface of the drum 117. Preferably, the rollers 114 can be relatively wide 174 such as ¼ to ½ the width of the drum 117, and can have a diameter similar to the diameter of the drum 117, for example. it should be appreciated that other diameters of the rollers 114 may also be provided. For example, the diameter of the roller can be sufficiently large to control the incoming material stream. That is, for example, when the high speed incoming stream diverges from the longitudinal direction, portions of the stream may contact an exposed surface of the rollers, which may pull the diverging portion down onto the drum and help crush and crease the resulting bunching material.

In one exemplary embodiment, the converting station 102 can include a pressing member 114 having an engaged position biased against the drum 117 for engaging and crushing the sheet material 19 passing therebetween against the drum 117 to convert the sheet material. The pressing member 114 can have a released position displaced from the drum to release jams. The converting station 102 can have a magnetic position control system configured for magnetically holding the pressing member 114 in each of the engaged and released positions. The position control system can be configured for exerting a greater magnetic force for retaining the pressing member 114 in the engaged position than for retaining the pressing member 114 in the released position.

For example, the pressing portion 113, which can include a pressing member 113, can be disposed about a pivot axis such that, ignoring gravitational force, the pressing portion 113 is substantially free to pivot in a direction tending to separating the rollers 114 from the drum 117 about the pivot point. To resist this substantially free rotation, the pressing portion 114 can be secured in position by a position control system configured to maintain the rollers 114 in tangential contact with the drum 117, unless or until a sufficient separation force is applied, and hold the rollers 114 in a released position, once released. As such, when the material 19 passes between the drum 117 and the roller 114, the position control system can resist separation between the pressing portion 113 and the drum 117 thereby pressing the stream of sheet material and converting it into a low-density dunnage. When the rollers 114 are released due to a jam or other release causing force, the position control system can hold the rollers 114 in a released position allowing the jam to be cleared and preventing damage to the machine, jammed material, or human extremities, for example.

The position control system can include one or more biasing elements arranged and configured to maintain the position of the pressing portion 113 unless or until a separation force is applied. In the exemplary embodiment, the one or more biasing element can include a magnetic biasing element 196, as disclosed in U.S. Publication 2012/0165172. The magnetic biasing element 196, shown in FIG. 7B, is positioned behind magnets 200 disposed on the central housing. The magnetic biasing element 196 resists separation forces applied to the pressing portion 113. Additionally, the position control system can also include a release hold element 198, as shown in FIG. 7B, configured to hold the pressing portion 113 in the released open condition once the separation force has been applied and the pressing portion 113 has been released. In the exemplary embodiment, the released hold element can also be a magnetic holding element 198. It is noted that the nature of the magnets can provide the hold down force to require the minimum release force, that is the force applied to overcome the magnetic force of the biasing element, in a manner such that the hold-down force diminishes as the pressing portion 113 is separated from the drum 117. As such, the biasing force of the magnets can be substantially removed when the pressing portion 113 is pivoted to its released position.

Once in the pressing portion 113 is released, the magnets in the release hold element can function to hold the pressing portion 113 in the released condition. In one configuration, the force it takes to release the pressing portion 113 can be greater than the force required to place the pressing portion 113 back into an engaged position. This releasing mechanism can be advantageous to situations in which the user incorrectly positions the sticker on the supply unit, for example, and the supply units and sticker causes the converting station 102 to jam. In such situation, once the release force is reached due to the jam, the pressing portion 113 can release to a release position allowing for the user to easily remove the jam and preventing damage to the converting station 102.

In the exemplary embodiment shown in FIGS. 7A-9, the actuator 111 may be controlled by a user, for example, electrically, such as by operating a foot pedal, a switch, a button, or other control. The actuator 11 is connected to a cylindrical driving drum 117 which is caused to rotate by the actuator 111. This embodiment can also include one or more drum guides 116 arranged on axial ends thereof in a lateral position relative to the feed direction. The drum guides 116 can help to guide the sheet material toward the center of the drum 117. The drum guide 116 can be operably connected to the drum 117 to rotate freely with or without the drum 117. As such, the drum guide 116 may be supported off of the drive shaft of the drum 117 via a bearing or other isolating element for allowing the drum guide 116 to rotate relative to the drum 117. In addition, the drum guide 116 may be isolated from the axial side of the drum 17 by an additional space, bearing, or other isolation element for minimizing the transfer of rotational motion from the drum 117 to the guide 116. In other embodiments, the outer drum guide 116 may be supported via a bearing off of the outer axial side of the drum 117 rather than off of the drive shaft, for example. While a drum 117 connected with a actuator 111 is disclosed in this embodiment as the driving portion for driving the line of material in the dispensing direction, it will be appreciated that other feed methods are possible, such as an automated motor.

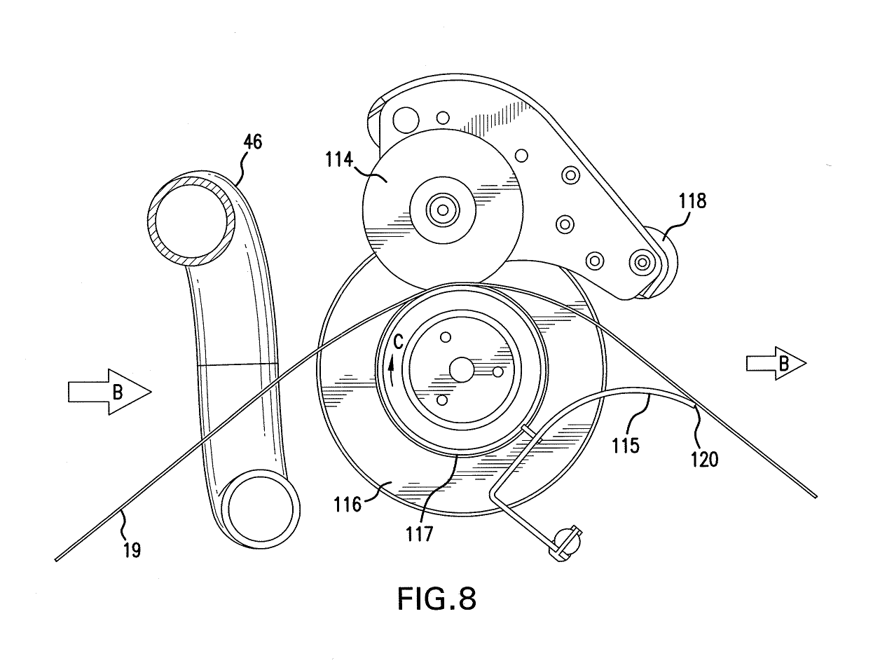

During operation, the actuator 111 dispenses the sheet material 19 by driving it in a dispensing direction, generally indicated by arrows “B” in FIG. 8. The supply material 19 is fed over the drum 117, thereby causing the material 19 to be driven in the dispensing direction when the actuator 111 is in operation. As the material 19 is fed through the system 10 in the feeding or dispensing direction “B”, including rotation of the drum 117 in the direction “C”, it passes over a cutting member 115. The cutting member 115 is curved downward so as to provide a guide for the path of the material 19 as it exits the system. The cutting member 115 includes a sharp cutting point 120 at the leading tip thereof, which may be a toothed configuration.

In one embodiment, a tear-assist apparatus moves the material 19 in a direction opposite the pulling direction, or a reverse direction. For example, the reverse movement may occur upon the user pulling the material 19 in a downward direction and engaging the material 19 with the cutting member 115. Where a cutter 115 is provided, the tear-assist apparatus pulls the material 19 in reverse to engage with the cutter 115 to more easily sever the material 19. However, a cutting member 115 does not need be present, for example where the material 19 is perforated, and the tear-assist may function to assist the user to sever the material 19 at the perforation.

The reverse movement of the tear-assist apparatus can be caused by a spring, a motor, which can be the actuator 111 as shown, an alternate motor, or other mechanical members.

Further, a sensing unit can be provided in some embodiments. The sensing unit can be operable to sense the pulling motion initiated by the user. As the user pulls on the material 19, the sensing unit detects a movement in the dispensing direction. The sensing unit can detect pulling initiated only by the user. When this movement is detected, the sensing unit sends a signal to the driving portion to initiate a short rotational force in the direction opposite the dispensing direction, thereby causing the material 19 to be pulled in a direction opposite what the user is pulling. The tear-assist thereby assists the user in tearing the material 19.

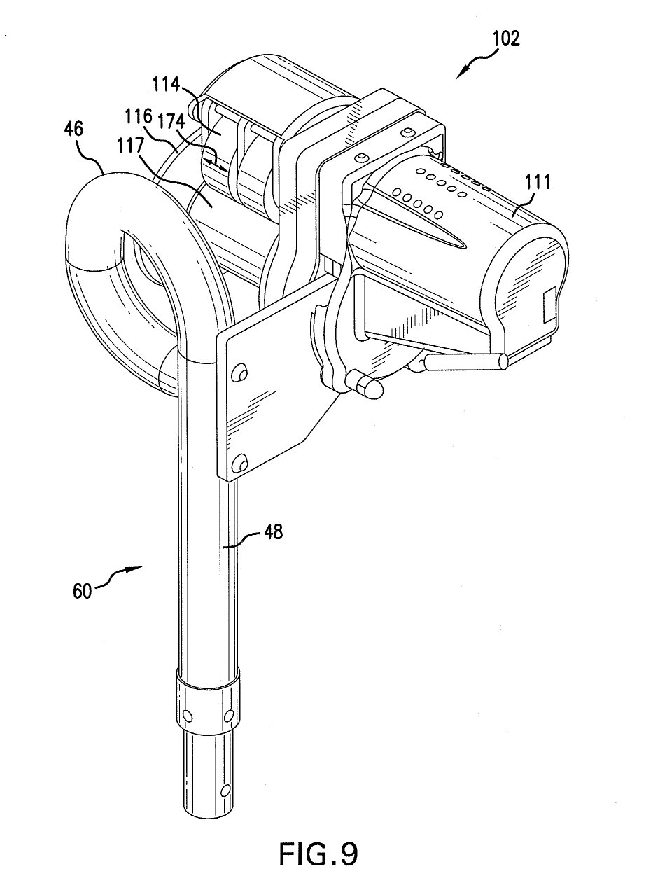

As shown in FIG. 9, the system 10 preferably can include a support portion 48 for supporting the station 2 and an inlet guide 46 for guiding the sheet material into the converting station 102. In the embodiment shown, the support portion 48 and the inlet guide 46 are shown combined into a single rolled or bent elongate element 60 forming a support pole or post. In this particular embodiment, the elongate element 60 is a tube having a round pipe-like cross-section. Other cross-sections may be provided.

The elongate element 60 may extend from a floor base 62, as shown in FIG. 1, and configured to provide lateral stability to the converting station 102. The elongate element 60 may be rigidly affixed to the floor base 62 to prevent relative translation or rotation of the element relative to the floor base 62. The floor base 62, which in the embodiment shown is configured for standing on the floor, can comprises of a plurality of crossing members. For example, the floor base 62 can comprise of a pair of first crossing member and a second crossing member connecting the pair of first crossing members. The floor base 62 can be adjustable to provide for leveling and stability. It can be appreciated that other shaped and configurations of the floor base 62 can be used, including, but not limited to, a broad shaped plate-like base, a configuration having multiple support rails 66, or a platform.

Preferably, the stabilizer 52 is affixed to the elongated element 60 of the converting station 102. However, in one configuration, as illustrated in FIG. 1, the converting station 102 can have a converting station floor base 64 separate from the stabilizer floor base 66 of the stabilizer 52, and the stabilizer 52 can be affixed to the stabilizer floor base 66. Whether or not a stabilizer is used, the floor bases 64 and 66 can both include wheels, which in some embodiments can include a locking mechanism, for easy movement. Having separate floor bases allows for the user to easily remove and position stacks of supply units into the converting station 102. For example, once a stack of supply has been converted, the user can roll a second stack into position for feeding into the converting station 102 without moving the converting station 102.

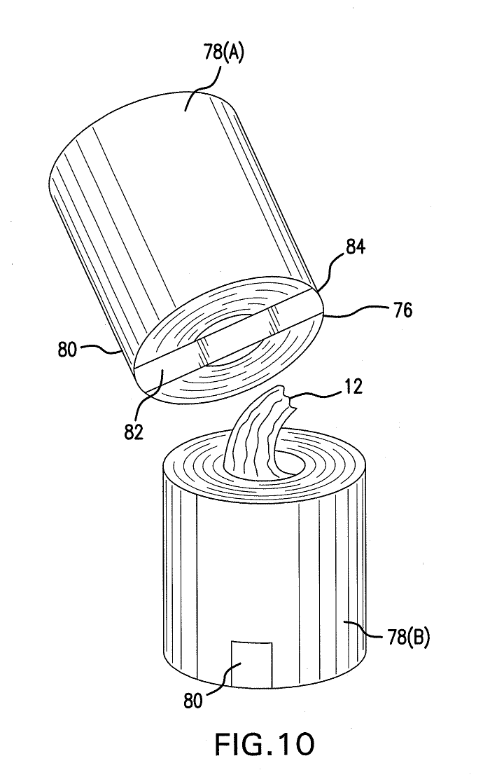

FIG. 10 illustrates an additional exemplary configuration of daisy-chaining or connecting multiple supply units to form an uninterrupted feed of sheet material. FIG. 10 depicts two supply units: the bottom angle side perspective of an upper exemplary supply unit 78(A) and a top angle side perspective of a lower exemplary supply unit 78(B). Each unit may include a receiving strip 76 that includes a tacky, sticky, or otherwise attachable material (e.g., an adhesive). The receiving strip 76 can have an adhesive coating on the exterior layer or side, the interior layer or side, or both the exterior and interior layers or sides of the strip 76. The exterior layer or side being defined as the portion of the receiving strip 76 facing outwardly and configured to attach to the inner end 12 of a preceding supply unit. The interior layer or side being defined as facing inwardly and opposite the exterior side.

In other embodiments, the receiving strip 76 further comprises a center portion 82 and two side portions 80 and 84. The side portions 80 and 84 can be positioned on either side of the supply unit 78(A) and 78(B). The side portions 80 and 84 can have an adhesive coating on the interior side of the side portion such that the side portions 80 and 84 sufficiently adheres to the side of the supply units.

Similar to the supply units, preferably rolls, described in FIGS. 1-6B, each unit includes a inner end 12 protruding from the inside of the unit. In the initial state, the inner end 12 may already be protruding from the inside of the unit 4, or the end 12 may need to be manually pulled from the center of the unit. When one unit 78(A) is stacked on top of another unit 78(B), the adhesive coating of strip 76 can bond with the inner end 12. Preferably, the inner end 12 bonds with the center portion 82 of the strip 76, such that the bond between the strip 76 and inner end 12 is further strengthened through the pressure of the weight of unit 78(A) when stacked vertically. Preferably, the bond created by the adhesive coating on the exterior side of the receiving strip 76 is stronger than the bond created by the adhesive coating on the interior side of the receiving strip 76. The strip 76, including the center portion 82 and side portions 80 and 84, may include an adhesive coating on both sides of the strip 76 (i.e. the exterior and interior layers), in just certain areas, or on just one side of the strip 76.

The exemplary embodiment shown in FIG. 10 includes an adhesive on substantially all or both the exterior and interior sides of receiving strip 76. In this configuration, when the supply material unit 78(A) comprises a roll, as illustrated in FIG. 10, the center portion 82 of the strip 76 adheres to multiple edges (e.g., one per turn on either side of the strip). The combined surface area of each thin edge can provide a combined adhesion to hold strip 76 to the bottom of supply unit 78(B). At the same time, because the adhesive bond between that one layer edge and the center portion 82 of the receiving strip 76 can be relatively weak in some embodiments, the arrangement still allows for the converting station 102 or dunnage supply mechanism to pull the supply material away from the roll one layer at a time.

Further, by protruding the inner end 12 of the next unit (e.g. 78(B)), such as by crumpling the end into a larger protrusion, or merely pulling out a flat portion of the material, the inner end 12 can automatically couple with center portion 82 of the receiving strip 76 once stacked, because inner end 12 can include sufficient surface area to create a sufficiently strong bond with the exterior adhesive coating of the center portion 82 of the receiving strip 76 to pull the connected strips through the converting station 102 without breaking or jamming the device. Once the preceding unit 78(A) reaches the end of its material supply, the side portions 80 and 84, being in contact with the surface of the supply material and not just the edge of that material, can ensure that the end of the supply material pulls along receiving strip 76, via side portion 80 and 84, and thereby pulls along the inner end 12 of the next unit 78(B).

In alternative embodiments of the exemplary configuration, the interior layer of the center portion 82 of the receiving strip 76 does not have an adhesive quality, and the side portions 80 and 84 act as the primary coupling of receiving strip 76 to the unit 78(A). In other configurations, the exterior layer of strip 76 can include an adhesive quality along its full length, only on the area expected to contact the inner end 12 of a second unit 78(B), or in some other area, such as only on the exterior layers of the side portions 80 and 84. In embodiments where the adhesive coating is located in an area that does not align with the inner end 12, the configuration can require a user to pull the inner end 12 out further, and manually affix it to the adhesive area when loading/stacking the supply units, for example onto the exterior layer of the side portions 80 and 84. Further, the strip 76 can include a protective layer, such as wax paper or anything else configured to protect the adhesive coating or layer until the protective layer is removed.

In addition to the receiving strip 76, as illustrated in FIG. 10, the strip 76 can have other shapes and configurations other than a longitudinal strip to capture more angles of the inner end 12 of proceeding units. Further, alternative embodiments can include a receiving strip 82 without any side portions 80 or 82, or with only one side portion 80.

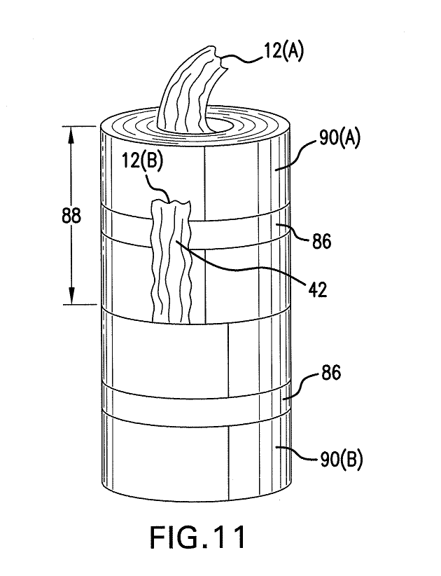

FIG. 11 illustrates yet another exemplary embodiment, including an upper supply material unit 84(A), e.g., a roll of supply paper, and a lower supply unit 84(B). The upper supply unit 84(A) includes a inner end 12(A) having a connecting portion 42, similar to that described in FIGS. 1-6B, and an adhesive strip 86 encircling the outer layer of the supply unit. Preferably, the adhesive strip 86 is positioned about the center or middle of the supply unit height 88, but in other embodiments, the adhesive strip 86 could be positioned elsewhere along the height 88 of the supply unit, such as the bottom or top of the outer layer, or the bottom surface, such as the exemplary embodiment illustrated in FIG. 10.

The inner end 12(A) is illustrated in FIG. 10 as protruding from the inner portion of the upper unit 90(A). However, it is appreciated that initially the inner ends 12 of the supply units could be protruding from the inner portion of the unit or could be fully within the inner portion of the unit, which may require removal of that end 12 during loading. Regardless of its initial position, the connecting portion 42 of the inner end 12(B) of a lower unit 90(B) can be affixed to strip 86 of the upper supply unit 90(A), thus forming a continuous chain between the two units. Similar to the adhesive strip discussed in FIG. 10, the adhesive strip 86 in FIG. 11 can include an adhesive quality on both the interior and exterior sides, one side, or any portion of either side. The adhesive strip 86 may also include a removable protecting layer. The exterior side being defined as the portion of the adhesive strip 86 facing outwardly and configured to attach to the inner end 12 of a bottom or second supply unit. The interior side being defined as facing inwardly and opposite the exterior side.

The adhesive strip 86 may fully encircle unit 84(A) and 84(B), as shown in FIG. 11, or may be present on only part of unit 84(A) and 84(B). For example, the strip 86 encircle only a portion of the unit. Further, while only one adhesive strip 86 is illustrated, each unit may include multiple and/or differing numbers of strips, which may be selected from by an end-user, or may be used in combination for added connection strength.

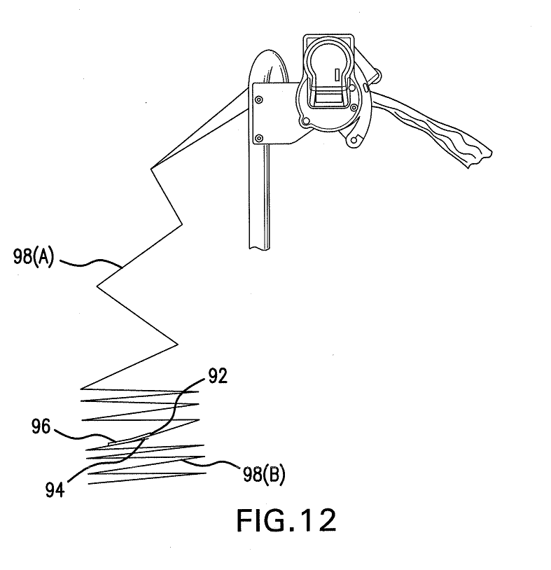

In yet another exemplary embodiment, illustrated in FIG. 12, the supply units can have a zig-zag, fan-fold arrangement, where the ribbon of the sheet material is folded back and forth over itself to form a stack of continuous material. The material can be perforated, such as at the bends, to facilitate folding and separately formed dunnage. The sticker 96 can be initially provided on the top end 94 of the lower supply unit 98(B), or on the bottom end 92 of the upper supply unit 98(A), with a release layer 20 on the sticker's connecting member 16. Once the release layer 20 is removed, the connecting member 16 can connect the bottom end 92 of the upper supply unit 98(A) to the top end 94 of the lower supply unit 98(B). Similarly, a sticker 96 can be used to connect the lower supply unit 98(B) to a supply unit below the lower supply unit (not shown), and so on, forming a continuous uninterrupted stream of material. In some embodiments, the top end 94 of the lower supply unit 98(B) can overlap the bottom end 92 of the upper supply unit 98(A) when the sticker 6 connects the two. The top end 94 of the upper unit 98(A) is fed into the converting station 102, as described above, where it is converted into a low-density material. Other types of supply unit arrangements can be used, for example, a tractor feed, stacks of sheet materials, and other similar arrangements. It should be noted that FIG. 12 depicts the sticker 96 initially on the top end 94 of the lower supply unit 98(B) and with the release layer 20 already removed; however, as described above, the sticker 96 with the release layer 20 can be initially provided separately from the supply units, and the user can lift the release layer 20 and position the sticker 96 on the supply units. Further, as described above, in alternative embodiments, sticker 96 can further include an additional release layer that lines the connecting member 16, or base member 18, or both (either as two individual release layers or one unified release layer). The user can then lift the additional release layer or layers from the sticker 96 and adhere it to the supply units.

Further, in yet another exemplary embodiment, the sticker can have an adhesive quality on both the top and bottom side of the sticker. As an illustrative example, the bottom of the sticker 96 in FIG. 12 can adhere to the top end 94 of the lower supply unit 98(B). The top of the sticker 96 can then adhere to the bottom end of the upper supply unit 98(A). Instead of top end 94 of the lower supply unit 98(B) overlapping the bottom end 92 of the upper supply unit 98(A), the sticker 96 is essentially sandwiched between the top end 94 of the lower supply unit 98(B) and the bottom end 92 of the upper supply unit 98(A).

In an alternative configuration, multiple supply units can be fed into the converting station 102 in parallel and the sticker 6 can be used to connect the inner ends 12 of the plurality of units. For example, the inner end of one supply unit or roll can be connected to another supply unit or roll. As described above, the sticker 6 can be initially disposed on one inner end 12 of one roll with the release layer 20 on the sticker's connecting member 16. Once the release layer 20 is removed, the connecting member 16 can connect the inner end with the inner end of another roll. Alternatively, the sticker 6 can be initially provided separately from the supply units. As described above, in alternative embodiments, sticker 6 can further include an additional release layer that lines the connecting member 16, or base member 18, or both (either as two individual release layers or one unified release layer). The user can then lift the additional release layer or layers from the sticker 6 and adhere it to the inner ends 12 of the rolls. The inner end of one roll can overlap the inner end of the other roll, or the inner ends can be disposed adjacent to each other with the sticker connecting the two.

Other aspects and configurations of the converting station is provided for in U.S. Application No. 61/537,021 and U.S. Publication No. 2012/0165172, both hereby fully incorporated by reference.

Any and all references specifically identified in the specification of the present application are expressly incorporated herein in their entirety by reference thereto. The term “about,” as used herein, should generally be understood to refer to both the corresponding number and a range of numbers. Moreover, all numerical ranges herein should be understood to include each whole integer within the range.

While illustrative embodiments of the disclosure are disclosed herein, it will be appreciated that numerous modifications and other embodiments may be devised by those skilled in the art. For example, the features for the various embodiments can be used in other embodiments. Therefore, it will be understood that the appended claims are intended to cover all such modifications and embodiments that come within the spirit and scope of the present disclosure.

1. A dunnage supply arrangement, comprising:
a first supply unit of an elongated web of material in a high-density arrangement, the material being convertible to a low-density dunnage in a dunnage mechanism, the elongated web of material having first and second longitudinal ends;
a connecting member disposed adjacent the first longitudinal end of the first supply unit, and including an adhesive surface configured for adhering to a longitudinal second end of a second supply unit of elongated web of material with sufficient adhesion for pulling the material of the second supply unit into the dunnage mechanism; and
a release layer disposed on the adhesive surface and releasable therefrom for allowing adhering to the second supply unit.

2. The dunnage supply arrangement of claim 1, further comprising a sticker that includes:
the connecting member; and
a base member adhered to the first longitudinal end of the supply unit.

3. The dunnage supply arrangement of claim 2, wherein the connecting and base members are disposed in longitudinal relationship with respect to each other, and the base member has a transverse width that is greater than the transverse width of the connecting member.

4. The dunnage supply arrangement of claim 1, wherein first supply comprises a roll of the material.

5. The dunnage supply arrangement of claim 4, wherein the axial height of the roll unit is greater than about 1 foot.

6. The dunnage supply arrangement of claim 4, wherein:
the first longitudinal end is an outer end of the roll; and
the second longitudinal end is an inner end of the roll that is extendible from an interior of the roll to attach to a connecting member of another supply unit of the web material.

7. The dunnage supply arrangement of claim 6, further comprising a sticker that includes:
the connecting member, which extends beyond the first longitudinal end of the roll; and
a base member adhered to the first longitudinal end of the roll.

8. The dunnage supply arrangement of claim 4, wherein the release layer is affixed to a portion of the web material adjacent and longitudinally beyond the first end of the roll.

9. The dunnage supply arrangement of claim 1, wherein the first supply unit comprises a stack of paper folded in fan-folded layers.

10. The dunnage supply arrangement of claim 1, further comprising a grasping portion longitudinally connected beyond the adhesive surface and the first longitudinal end, the grasping portion being substantially free of adhesive to facilitate grasping of the connecting member to peal the adhesive surface from the release layer.

11. A dunnage converting system, comprising:
the dunnage supply arrangement of claim 1; and
a dunnage mechanism configured for converting the web material into the low-density dunnage;
wherein the second end is loaded into the dunnage mechanism.

12. The dunnage converting system of claim 11, wherein the dunnage arrangement comprises the second supply unit, which is of similar construction to the first supply unit, a second longitudinal end of the second supply unit is positioned for adhering to the adhesive layer of the connecting member of the first supply unit when the release layer is released therefrom.

13. The dunnage converting system of claim 12, wherein the first supply unit is stacked on the second supply unit with the second longitudinal end of the second supply unit disposed adjacent the connecting member of the first supply unit for adhering thereto.

14. The dunnage converting system of claim 13, wherein the supply unit is a roll, and the second end of the second supply unit extends out from the center of the second roll from between the stacked rolls.

15. The dunnage converting system of claim 12, wherein the dunnage arrangement comprises a third supply unit, which is of similar construction to the second and first supply units, a second longitudinal end of the third supply unit is positioned for adhering to the adhesive layer of the connecting member of the second supply unit when the release layer is released thereform.

16. The dunnage converting system of claim 15, wherein the second supply unit is stacked on the third supply unit with the second longitudinal end of the third supply unit disposed adjacent the connecting member of the second supply unit for adhering thereto.

17. The dunnage converting system of claim 16, wherein the supply unit is a roll, and the second end of the third supply unit extends out from the center of the third roll from between the stacked rolls.

18. A dunnage supply arrangement, comprising:
a first supply unit of an elongated web of material in a high-density arrangement, the material being convertible to a low-density dunnage in a dunnage mechanism, the elongated web of material having first and second longitudinal ends;
a sticker comprising:
a connecting member extending beyond and adjacent the first longitudinal end of the unit; and
a base member adhered to the first longitudinal end of the unit; and
a release layer affixed to a portion of the web material adjacent and longitudinally beyond the first end of the unit;
wherein the connecting member further includes an adhesive surface configured for adhering to the release layer and releasable therefrom to allow adhering to a longitudinal second end of a second supply unit of the elongated web of material with sufficient adhesion for pulling the material of the second supply unit into the dunnage mechanism.

19. The dunnage supply arrangement of claim 18, wherein the supply unit is a roll and the second longitudinal end is the inner end of the roll extending therefrom.

20. A dunnage supply arrangement, comprising:
a first supply unit of an elongated web of material in a high-density arrangement, the material being convertible to a low-density dunnage in a dunnage mechanism, the elongated web of material having first and second longitudinal ends; and
a connecting member having at least one adhesive surface portion and disposed on the supply unit such that the adhesive surface faces outwardly.

21. The dunnage supply arrangement of claim 20, wherein the supply unit is a roll of material.

22. The dunnage supply arrangement of claim 21, wherein the connecting member is a strip that is disposed on the outer layer of the roll with the adhesive facing outwardly and the first supply unit is stacked on a second supply unit, the second longitudinal end of the second supply unit adhering to the outward adhesive surface of the connecting member of the first supply unit.

23. The dunnage supply arrangement of claim 21, wherein the supply unit is a roll and the connecting member is a strip disposed on the bottom surface of roll, and the first supply unit is stacked on a second supply unit, the second longitudinal end of the second supply unit adhering to the outward adhesive surface of the connecting member of the first supply unit.

24. A method of loading a dunnage mechanism, comprising:
pulling an inner end of a first roll of an elongated web of material from a first roll;
removing a connecting member disposed at the outer end of a second roll of an elongated web of the material from a release layer disposed on the outer layer of the second roll;
stacking the second roll on the first roll with the inner end extending between the first and second rolls; and
affixing the connecting member of the second roll to the inner end of the first roll to pull the inner end of the first roll into the dunnage machine, which is configured for converting the material into low-density dunnage.
